(19) United States
(12) Patent Application Publication
(10) Pub. No.: US 2011/0004984 A1
(43) Pub. Date: Jan. 13, 2011

(54) CONTROLLABLE RIBBED THERMOINSULATIVE CHAMBER OF CONTINUALLY ADJUSTABLE THICKNESS AND ITS APPLICATION

(76) Inventors: Snjezana First Rogale, Senkovec (HR); Dubravko Rogale, Senkovec (HR); Gojko Nikolic, Zagreb (HR); Zvonko Dragcevic, Zagreb (HR)

Correspondence Address: RATNERPRESTIA, P.O. BOX 980, VALLEY FORGE, PA, 19482, US

(21) Appl. No.: 12/922,761

(22) PCT Filed: Mar. 16, 2009
(86) PCT No.: PCT/HR2009/000008

§ 371 Date: Sep. 15, 2010

(30) Foreign Application Priority Data
Mar. 17, 2008 (HR) P20080116A
Mar. 19, 2008 (HR) P20080118A

(51) Int. Cl. A62B 17/00; B32B 3/30; B32B 1/00; B32B 3/12

(52) U.S. Cl. 2/458; 428/12

(57) ABSTRACT

A controllable ribbed thermoinsulative chamber of continually adjustable thickness, which is used to pneumatically determine its thermal conductivity. Described is the manner of constructing such a chamber and the manner of controlling it. The abovementioned chamber is used in designing articles of clothing with a self-regulating thermal insulation. One or more chambers are used in the construction, together with adequate devices for controlling and monitoring the workings of thermoinsulative chambers. Special attention is paid to the construction of forced ventilation of the garments designed in the above way. The garments designed in the above way are suitable for police usage, maintenance services, watchmen services, security of the open objects and premises, workers in cold storages, athletes like mountain climbers, alpinists, sailing boaters and the like, wherever the temperature of the environment is radically changed in the course of usage.

### FIELD OF INVENTION

This invention refers to controllable ribbed thermoinsulative chambers, the thickness of which, and indirectly its thermoinsulative properties, can continuously and controllably be adjusted. They can be applied in garment manufacturing technology and/or any other wrapping where the thermal protection value is to be changed according to a previously determined protocol of behavior.

### TECHNICAL PROBLEM

The issue of forming technical barriers (insulation, that could offer the change of heat transfer properties to request, is evident in textile industry and in some other industries as well. The technical problem solved by this invention is the construction of such barriers that could change their properties automatically, according to a pre-set protocol, and in relation to the changes in the environment, registered by sensors, and in a manner that is aesthetically and functionally acceptable.

The first technical problem solved by the described invention is related to the construction of the ribbed thermoinsulative chamber, the thickness of which can be continually changed, which impacts heat transfer through it.

The second technical problem solved by the described invention concerns garment construction, or the construction of other articles that use the advantages of the controllable ribbed thermoinsulative chamber in product design, together with its considerably enhanced thermoinsulating properties and the possibility of regulating these properties in accordance to the environment parameters, or some other pre-determined protocol.

### DESCRIPTION OF PRIOR ART

The document EP1280440(B1) (EMPA, from 2000) discusses a technical solution of the above technical issue by which the amount of gas in chambers is controlled by sensors and the thermoinsulative chamber is additionally filled with feathers or loose textile fibers, which give thickness or necessary bulk to the chamber. This additional filler makes the manufacture of such chambers more difficult, causes additional costs in procurement of material, makes the product more expensive and additionally increases the weight of the chamber, i.e. increases the overall mass of the product, which reduces its comfort in wearing. When using the chamber, and especially in wearing the garment, the filler is compressed in the lower parts of the garment (filler migration), the thermoinsulative chamber is distorted and the aesthetics of the garment in impaired, while the uniformity of the insulation properties is reduced as well. In this invention, chamber thickness is reduced by sucking-out (by vacuum) the air from the chamber, which reduces insulation properties proportionally to the amount of air removed. However, repeated compression and stretching of the chamber additionally compresses the filler, which makes it almost impossible to find a reproducible, which means correct, relationship between the chamber thickness and negative pressure in the chamber. This is why it is necessary to calibrate the chamber from time to time and determine the correlation of its thickness and negative pressure in it, particularly so if the chamber is linked to an automatic control unit. The invention described in this patent application has eliminated all of the above disadvantages.

The international patent application PCT/HR2004/000026, published as WO2005023029 (Rogale et al.), offers thermoinsulative sealing chambers with no filling. This technical solution exhibits a number of disadvantages. Active thermal protection is achieved through various combinations of activating shoulder, breast or waist sealing chambers, which stimulates or prevents the chimney effect within the article of clothing in question. The chambers act employing the principle of full/empty, or activated/deactivated, meaning only two extreme positions are possible. When activated chamber is used it seals the space between the outer garment shell and the body, enabling the chimney effect, while the deactivated chamber allows for the circulation of the air. This does not allow for intermediate positions, meaning controlled thickness is not possible, and different levels of thermal protection are achieved through various combinations of activated and deactivated chambers, or, precisely, only six discreet states of thermal protection can be achieved. Activation and deactivation of the chambers asks for high expenditure of compressed air, and can hardly be accepted from the point of view of rational consumption of compressed air, particularly so as some chambers are often completely emptied of air, while the others are inflated, and in the immediately following level of protection the inflated chambers should be deflated, new ones activated etc. This mode of work results in high consumption of electrical energy to power the microcompressor, which can be a considerable problem when autonomous power sources are used, since batteries have definitely limited capacity. A discreet mode of activating at the position of the activated chamber seals the air flow, stops ventilation and the circulation of the air, which brings thermal protection to a maximum. When the chambers are not activated circulation is free and thermal protection is at its minimum. It is thus possible that some parts of the body have maximal thermal protection and the neighboring ones minimal. A subjective feeling of warmth can appear at one part of the body and the feeling of coldness in its proximity. Completely inflated chambers stretch, in principle, in the directions of minimum resistance, which means not uniformly, so distortions of shape and chamber thickness are possible, which can have an adverse impact on the garment aesthetics. The invention described in this patent application has eliminated all of the above disadvantages.

It can be noted that the above mentioned technical solution WO2005023029 uses temperature sensors only to estimate thermodynamic conditions, while the usage of the sensors and measuring of air relative humidity is mentioned only in the document EP1280440, with no causal relation established with the thermal flow in the chamber. The documents mentioned contain no indication of the manned of leading the condensate from the chambers nor of forced ventilation when maximum thermal conduction of the barriers is not enough to establish adequate microclimatic conditions within the article of clothing.

### THE SUMMARY OF THE INVENTION

The invention described primarily relates to the controllable ribbed thermoinsulative chamber of continuously adjustable thickness, which determines thermal conductivity of the chamber. The invention deals with the manners of construction and control of such a chamber.

The above chamber is used in designing articles of clothing with self-regulating thermal insulation. One or more chambers are used in constructing clothing, together with the appropriate equipment for control and management of the thermoinsulative chamber workings. Special attention is paid to the variant with enforced ventilation, when designing articles of clothing of this type.

### BRIEF DESCRIPTION OF THE DRAWINGS

The accompanying figures, included in the description, which constitute an integral part of the description of the invention, illustrate the best analyzed and realized manner for the realization of the invention until now. They also help in explaining the basic principles of the invention.

FIG. 1 represents controllable ribbed thermoinsulative chambers of continually adaptable thickness, with basic elements of construction.

FIG. 2 represents a sample of deflated thermoinsulative chamber.

FIG. 3 shows a cross-section of the sample of inflated thermoinsulative chamber.

FIGS. 4A-4H show the schemes of measuring samples of thermoinsulative chambers with variable step and variable number of chamber segments.

FIG. 5 shows the manner of testing thermoinsulative chamber data, using battery-operated hand compressor, digital pressure measuring instrument and linking pneumatic elements.

FIG. 6 shows a graph of the correlation of the inflated thermoinsulative chamber height and the steps of thermoinsulative chambers (Kₖ).

FIG. 7 shows the dependence of the filling factor (fᵢ) on the values of the thermoinsulative chamber step (Kₖ).

FIG. 8 shows a graph of the correlation of length contraction coefficients of the inflated measuring samples (K_{d}) and the steps of the thermoinsulative chambers (Kₖ).

FIG. 9 shows a graph of correlation of the width contraction coefficients of the deflated measuring samples (K_{\check{s}}) and the steps of the thermoinsulative chambers (Kₖ).

FIG. 10 represents an inset of the adaptive article of clothing, with the constructed segmented thermoinsulative chambers, linking channel structures with the networks or semi-transparent membranes, as well as main construction elements positioned on the girth carrier.

FIG. 11 shows a scheme of connecting micropneumatic elements (microcompressors, hand pump, air duct, electrovalves, exhaust valves and jets).

FIG. 12 shows electrical schemes of the control system, with two microcontrollers intended for measuring and control of the workings of the garment with adaptive microclimatic conditions.

### DETAILED DESCRIPTION OF THE INVENTION

Detailed description of the invention will show the functionality and the construction results of the thermoinsulative chamber, as well as an example of designing an article of clothing with the chambers incorporated according to the invention, which can be adapted to the microclimatic conditions (and the protocol incorporated) of the microcontroller.

### Thermoinsulative Chamber

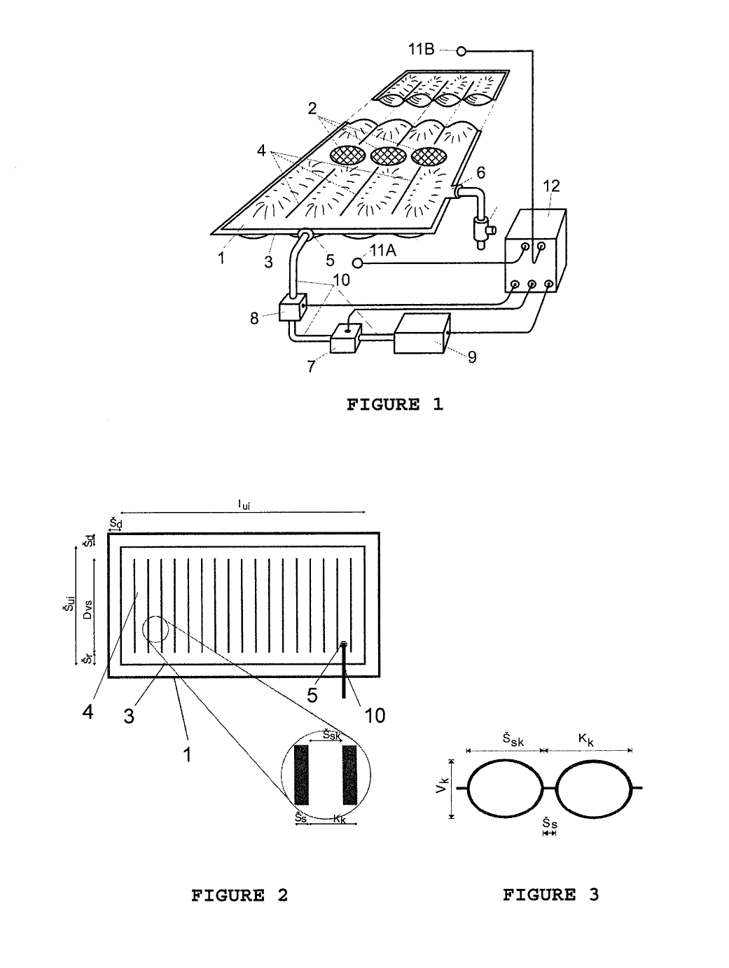

FIG. 1 shows a controllable ribbed thermoinsulative chamber of continually adaptable thickness (1) made of a thin polymer foil and optionally braided with elastic knitted fabric, for the purpose of forced deflating, with ultrasound-welded airtight seams (3) and inner seams (4), which result in the ribbed structure. The lower end of the ribbed structure mentioned exhibits openings for inflating and deflating of the compressed air (5), as well as for the discharging of the condensate (6). A detachable carrier is situated by the edge of the chamber, with sets of pneumatic electrovalves (7) for filling and emptying the chamber, a pressure sensor (8), microcompressor (9) and air ducts (10), and beside them the sensors for the thermodynamic conditions of the environment (11A, 11B), controlling system (12), power and bus systems.

Chamber thickness and its thermoinsulative properties depend on the chamber construction parameters, or, more precisely, on the distance between the inner seams (4). These properties are continually being changed, depending upon the pressure of the air being blown into the chamber through the openings (5), measured by a sensor (8), so that the sensors (11A, 11B) and the control system (12) are used to control, manually or automatically, the thermal properties of the chamber by controlling the sets of valves (7).

FIG. 2 shows the lengthwise cross-section of deflated thermoinsulative chambers, with the distance between the inner seams enlarged (4), and measures which will be discussed in detail later on, while the FIG. 3 shows the cross-section of the inflated chambers.

Further discussion describes one of the ways of constructing thermoinsulative chambers according to the invention submitted. The foils made by Bayer Epurex GmbH, Germany, prove to be superior to other similar types of polymer high-elastic foils tested for the purpose of making the thermoinsulative chambers. All the foils were submitted to extreme strains and pressures, and the best results were obtained by the high-elastic foil designated Walopur 4201AU.

The above foil is characterized by material density of 1.15 g/cm³, the softening point at 140-150° C., and quite high elongation at the breaking point—550%. Apart from that, the material is characterized by high UV fastness, hydrolytic fastness, ability to be joined by heat and ultrasound methods, as well as good microbial resistance, especially important for incorporation of the chambers into garments, blankets, sleeping bags, in warming-up and saving people exposed to extreme cold, protective garments for infants, and similar end-uses involving human bodies or the bodies of other living creatures.

The high-elastic polyurethane foil selected exhibits better joining properties when ultrasound is used, than when using the method of joining by hot wedge or hot air stream, which is a key factor in making the choice, and which influences the ribbed design of the chamber.

Measuring samples of thermoinsulative chambers are joined using a special ultrasound machine for joining synthetic polymer foils. The machine was manufactured by PFAFF, and designated Seamsonic 8310-003. It joins polymer materials using an ultrasound sonotrode, which works at the frequency of 35 kHz. Ultrasound vibrations are transferred to a rotating disc, made of an aluminum-titan alloy, of 105 mm diameter, a width from 2 to 10 mm. Joining rate is from 0.6 to 13.6 m/min.

The thickness of the composite material should be in the range from 50 μm to 2 mm. The distance between the sonotrode and counter roller can vary, with the accuracy of 20 μm and joining force of 0-800 N. The machine is equipped with a processing microcomputer, which calculates and adjusts the continuing density of the ultrasound energy of joining, at variable joining speeds, which results in visually uniform joints and high strength of the ultrasound joint.

The length of the laboratory samples of the thermoinsulative chamber used for testing purposes, as can be seen in FIG. 2, when deflated (lᵤᵢ) ranges from 8850 to 9440 mm, while the width of the deflated thermoinsulative chamber samples (\check{S}ᵤᵢ) is from 4350 to 4430 mm.

The width of the ultrasound joint, i.e. weld (\check{S}ₛ) is 8 mm, while the outer joining accessories of the thermoinsulative chambers (\check{S}_{d}) are 20 mm. The length of the ultrasound joint of the thermoinsulative chamber joints(Dᵥₛ) ranges from 3350 to 3430 mm, while the width of the bottom and upper edge of the thermoinsulative chamber (\check{S}ᵣ) is 50 mm.

The samples are constructed so that segments of the chambers of different widths are taken, the chamber segment width (\check{S}ₛₖ), together with the additional seam (\check{S}ₛ), of 8 mm constituting so called chamber step (Kₖ). Eight measuring samples of the thermoinsulative chambers are selected, with the chamber steps from 30 to 100 mm. The cross section of the inflated thermoinsulative chamber sample, with the height of the chamber (vₖ) indicated, can be seen in FIG. 3.

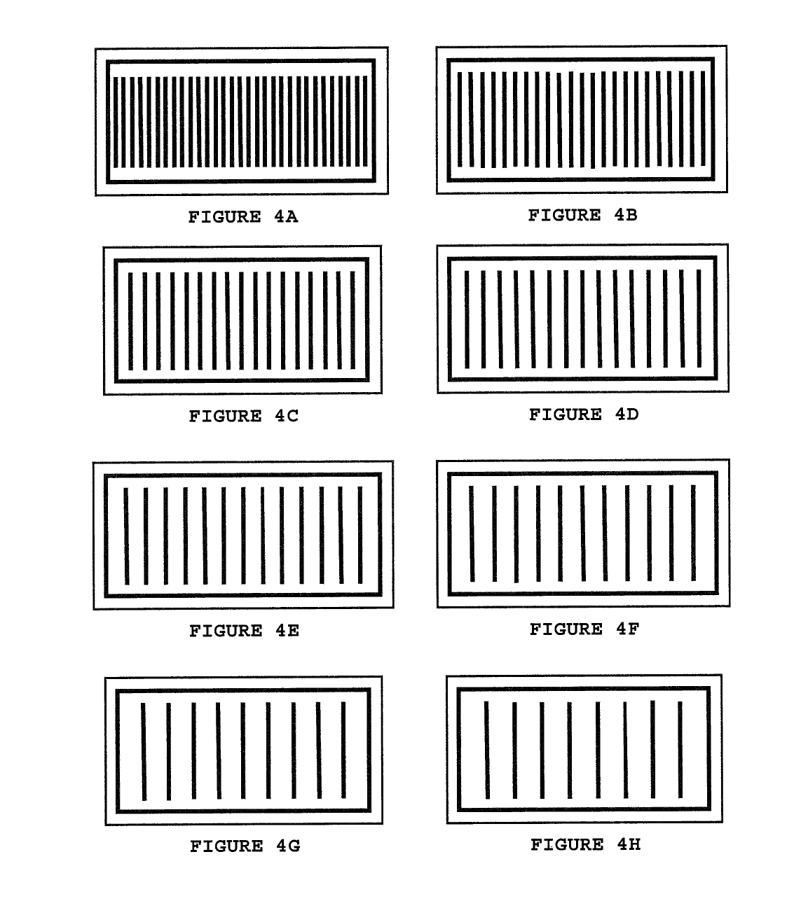

Visualization of the deflated thermoinsulative chamber samples can be seen in FIGS. 4A to 4H, for the chambers with the parameters as presented in the following table:

| | Average chamber | Number of chamber |
|---|---|---|
| Figure | step (m) | segments |
| 4A | 30 | 32 |
| 4B | 40 | 24 |
| 4C | 50 | 18 |
| 4D | 60 | 16 |
| 4E | 70 | 14 |
| 4F | 80 | 12 |
| 4G | 90 | 10 |
| 4H | 100 | 9 |

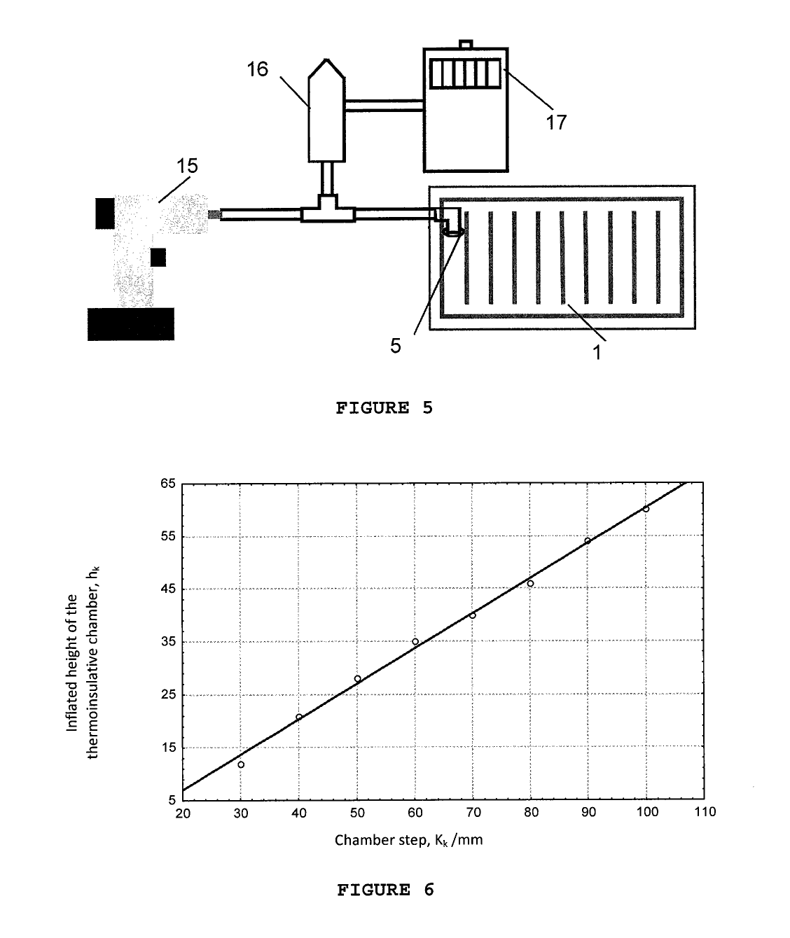

Thermoinsulative chamber (a) behavior is tested using a battery-operated hand compressor (15), a digital pressure measuring device (17) with a sensor (16), and linking pneumatic elements, in the manner shown in FIG. 5.

A hand compressor Einhell Bavaria, designated BAL 9.6, is used to test the characteristics of thermoinsulative chambers. A polyurethane plastic flexible air tube, designated PUN-4x0, 75-BL, by the company of FESTO, is chosen to deliver compressed air to the linking micropneumatic components used to test the thermoinsulative chamber characteristics.

L-shaped plug-in joints, designated QSLM-1/8-4-100, are used to connect the tubes to the attachment cone-shaped element of the thermoinsulative chamber, while T-shaped plug-in joints, designated QSMT-4, from the Quick Star series of screw joints are used for other connections. All the joints belong to the product range of the company FESTO.

Digital pressure measuring instrument designated GDH12AN, Greisinger electronic GmbH, from Regenstauf, Germany, is used to measure the pressure in the chambers. The instrument can measure absolute pressure in the range from 0 to 1300 mbar. It should be noted that the highest allowable pressure at the sensors attached should not exceed 2 bars.

Sensor resolution is 1 mbar at the temperature of 25° C., the error caused by the temperature shift of the sensor being low—only 0.01%/K.

Pressure sensor is situated at the bridge joint of piesoresstive elements. It is located in a separate plastic housing, dimensions of 68×26×15 mm (l×w×h), on which a measuring connection, with the outer diameter of 5 mm is situated, intended for the connection of standard pneumatic tubes 6×1 (6 mm of the outer diameter and 1 mm of the wall thickness). The sensor is connected with the digital measuring instrument using a flexible cable and 4-pole MiniDIN connector. The measuring sensor is compensated thermally in the temperature range between 0 and 70° C., and can measure pressure of non-corrosive and non-ionizing gasses and liquids.

The tests on the measuring samples of thermoinsulative chambers are performed in order to establish dimensional changes of the thermoinsulative chambers when inflated and the height of the thermoinsulative chambers when inflated as well.

The measuring data acquired are used as a basis of calculating the filling factors (fᵢ), measuring sample length contraction coefficients in inflated state (K_{d}) and measuring sample width contraction coefficient in inflated state (K_{\check{s}}).

The filling factor (fᵢ) is the ration of the inflated thermoinsulative chamber height, at the pressure of 50 mbar (hₖ) and the chamber step of the thermoinsulative chambers (Kₖ). It is calculated according to the following equation:

$${f}_{i} = \frac{{v}_{k}}{{k}_{k}} \qquad ( 1 )$$

The length contraction coefficient of the inflated measuring sample (K_{d}) is defined as the ratio of the deflated sample length and inflated sample length, at the pressure of 50 mbar, and is calculated as follows:

$${K}_{d} = \frac{{I}_{un}}{{I}_{ui}} \qquad ( 2 )$$

The width contraction coefficient of the inflated measuring sample (K_{\check{s}}) is defined as the ratio of the deflated sample width and inflated sample width, at 50 mbar, and is calculated as follows:

$${K}_{{s}^{⋁}} = \frac{{{S}^{⋁}}_{un}}{{{S}^{⋁}}_{ui}} \qquad ( 3 )$$

FIG. 6 shows a graph depicting the dependence of the inflated thermoinsulative chamber height (hₖ) at the pressure of 50 mbar, and chamber steps (Kₖ).

Regression analysis performed showed that the height of the inflated thermoinsulative chambers, as related to the chamber steps, can be calculated using the following equation:

hₖ=0.667·Kₖ−6.333 (4)

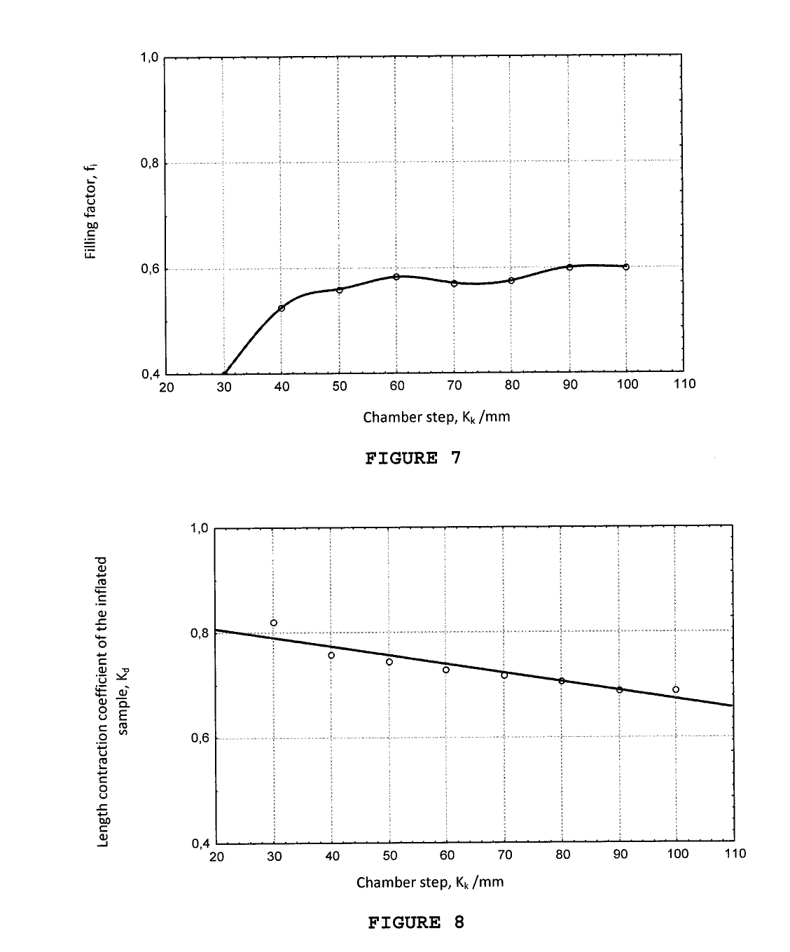

A graph showing the dependence of filling factors (fᵢ) on the thermoinsulative chamber steps (Kₖ) can be seen in FIG. 7.

FIG. 8 shows a graph of the dependence of the inflated measuring sample length contraction coefficients (K_{d}) on the thermoinsulative chamber steps (Kₖ).

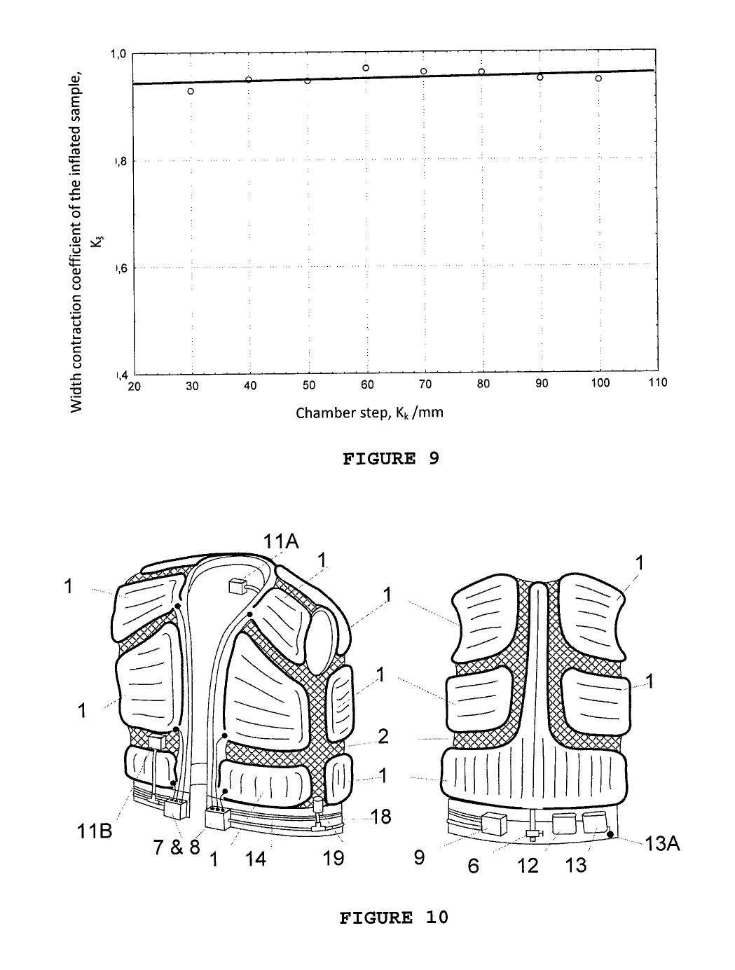

FIG. 9 shows a graph of the dependence of the inflated measuring sample width contraction coefficient (K_{\check{s}}) on the thermoinsulative chamber steps (Kₖ).

The investigations performed have indicated the manner and conditions of applying and realizing the invention. It has been established that the changes in the thermoinsulative chamber thickness result in the changes of the dimensions of the chamber as well. Since they are known, they can be accounted for in the construction of the chamber, i.e. in realizing the invention.

The data obtained offer a sound basis for programming the microcontroller that regulates the conditions of the chamber in designing garments or similar products.

It is obvious that the described controllable ribbed chambers can be linked so that two or m ore of the chambers are joined together and together form a temperature bridge, i.e. thermal insulation of an object, with pre-defined parameters of the object inner microclimatic conditions.

It can be done in a number of ways, but, generally, the data from each of the chambers, collected by the sensors for thermodynamic conditions of the environment (11), for each of the chambers (1), are passed to one or more microcontrollers that regulate the pressure in one or more of the abovementioned chambers, aided by one or more microcompressors and valve systems that adapt the pressure in the chambers according to the pre-determined values of the protocol, programmed in the abovementioned microcontrollers. All of this is done in order to establish target thermal bridges of the object and its environment, which in turn results in warming-up or cooling-down of the object. A good example of such centrally controlled use of more chambers according to the invention described is discussed in the following:

### Example of Embodiment: An Article of Clothing with Adaptive Microclimatic Conditions

The thermoinsulative chambers described and analyzed above have been designed primarily to be used with articles of clothing that are able to change their thermal insulation.

Basic notion is that, within a rather broad temperature range, optimal microclimatic conditions can be obtained within an article of clothing.

The chambers described regulate their thermoinsulative properties by increasing the air layer within, which results in an increased resistance to thermal conduction, from one side of the chamber to the other, i.e. the characteristics of the thermal bridge constituted by the chambers are changed.

In this way, body temperature of the wearer of such clothes is preserved in much higher extent than otherwise. Thermoinsulative chambers are situated between the outer shell of the garment and its interlining, as an independent and complete insert, and consist of a number of smaller chambers, anatomically shaped, so as to match easily the shape of the body of the wearer.

The construction of the insert is based on the application of numerous segmented thermoinsulative chambers, designed according to anthropometric measures of the wearer population (men, women and children of various ages and various body statures). It offers a new manner of segmented thermal protection for parts of human body, so that more sensitive body parts are layered with chambers of various thicknesses, which can, at the same level of pressure, be of different thickness. In this way, the level of heat protection is varied in a pre-determined and controlled manner, according to the individual needs of the wearer.

The segmentation of the chambers is also used to introduce some new and additional technical solutions. The first consists in connecting the thermoinsulative chamber using net-like fabrics, or using broad tapes cut from semi-permeable fabric membranes of some new materials (Goretex, Simpatex), which are well available on the market. Net-like structures and semi-permeable membranes let the sweat-saturated air pass through, eliminating the sweat from the body.

Second—chambers can be ergonomically shaped, so that they do not bend at extreme ergonomic movements of the body, since the insert is bent at the joints of individual chambers. This preserves the original shape of the segmented chambers, keeping their thermal conductivity and garment aesthetics unchanged.

In case of too high temperature in the garment microclime, when the chambers are completely deflated and the garment offers minimal thermal protection, and when even this is not enough to establish comfortably microclimatic conditions, additional forced air circulation within the article of clothing is provided. In this situation, the compressed air, normally used to fill the chambers, is re-directed to cooling jets. Cooling jets are positions, as will be explained later, at the front, side and back centre of the garment, in principle beside the connecting channel structure created by linking the segmented chambers with net-like fabrics or semi-permeable membranes. Sweat-saturated air is circulated forcedly in this area of the garment, and the air forced into the connecting channels will additionally stimulate evaporation and elimination of sweat, which will result in additional cooling of the body and comfortable microclimatic conditions within the garment.

The aim is to adapt microclimatic conditions within the garment in an automatic manner, according to the pre-determined protocol. Various sensors are used for the purpose (temperature, relative humidity of the air, thermal flow, sweating, air flow velocity), used to monitor the overall thermodynamic conditions of the garment environment and its microclimatic conditions, together with the control microcontroller-based control system, which gathers and interprets the results obtained by sensors and brings adequate decisions. To realize these decisions, the system is also equipped with additional integrated micropneumatic elements (electrovalves, air ducts, microcompressor), with an electric power system and buses, which makes it able to automatically increase and adapt the necessary thermal protection to a cold environment, or initiate forced internal circulation with the aim of cooling the body and ensuring comfortable microclimatic conditions within the garment.

In case of battery failure, or failure of some other technical system, manual pumping of the air into the thermoinsulative chambers can be accomplished, using a hand pump.

This construction additionally offers elimination of the water condensed in the chambers by positioning an exhaust valve at the bottom of the chamber, which lets the condensate leave the chamber when necessary.

In the application described, some of the sensors, electrovalves, microprocessors, air ducts, jets, control system, battery set and buses are concentrated on the carrier and attached to the seam or welt of the garment. The carrier of the components can easily be detached from the chamber, which is accomplished by using buckles, buttons, press fasteners, zip fasteners, hook-and-eye fasteners and similar means. The idea is to make easier the manufacture of the garment separate from the chambers, to minimize fabric consumption, to enable easy, fast and simple mounting of the chambers, simplify maintenance, repair or substitution of faulty elements. There are two additional advantages of positioning above elements beside the garment seams: sharp edges of the elements cannot damage the chambers and do not impair the aesthetics of the upper part of the garment, while the weight of the carrier is evenly distributed and uniformly pull the garment downwards, which contributes to the appearance and drape.

An article of clothing with the above listed properties and adaptive microclimatic conditions can be seen in FIG. 10 (front and back view). It consists of more anthropometrically shaped segmented thermoinsulative chambers (1), connected with a net-like structure or semi-permeable membrane (2), situated between and outer basic fabric and the interlining. The lower part of the garment welt harbors the detachable carrier (18) with sets of valves (7) for inflating and deflating the chambers and with incorporated pressure sensors (8), a bus (14), a microcompressor (9), controlling microprocessor system (12), a battery set (13) and the attachment for charging the batteries (13A). The article of clothing shown also has two sets of sensors for measuring thermodynamic conditions of the outside environment (11B) and inner microclimatic conditions (11A). These sensors include temperature sensors and humidity sensors. In cold conditions, compressed air is blown into the chambers, which continually increase their thickness as the pressure grows. Chamber thickness is decreased in warm conditions by letting the air out, and when special needs arise, additional forced circulation is activated through jets (19) situated by the connecting channel structure. The condensate is released through a valve (6). In case of battery failure or some failure of the system, it is possible to empty or fill the thermoinsulative chambers (1) using a hand pump (21), which is attached to the air duct by attaching, joints (20). The chamber system is covered with a tight knitted fabric, which enhances deflating of the chambers by pressing them lightly and evenly, thus pushing the air out of the chambers.

Thermoinsulative chambers can be joined by sewing, by ultrasound, thermal or high-frequency techniques, as well as by gluing.

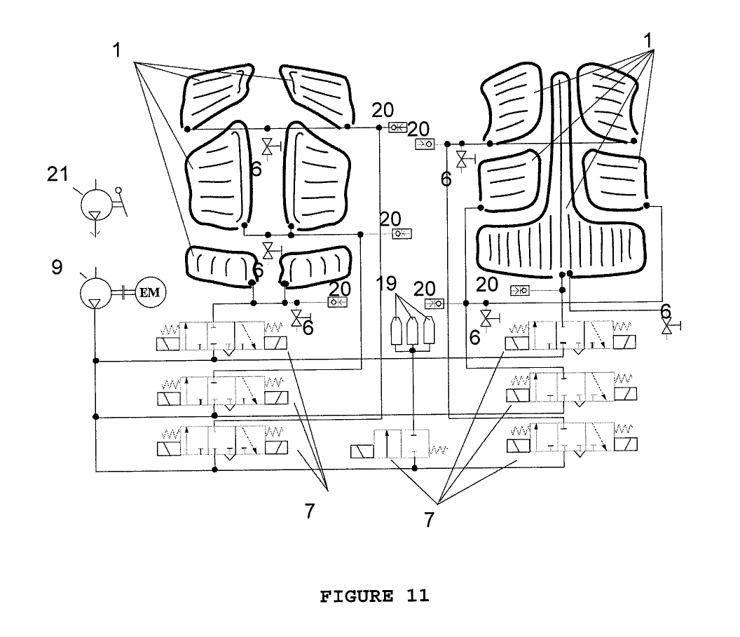

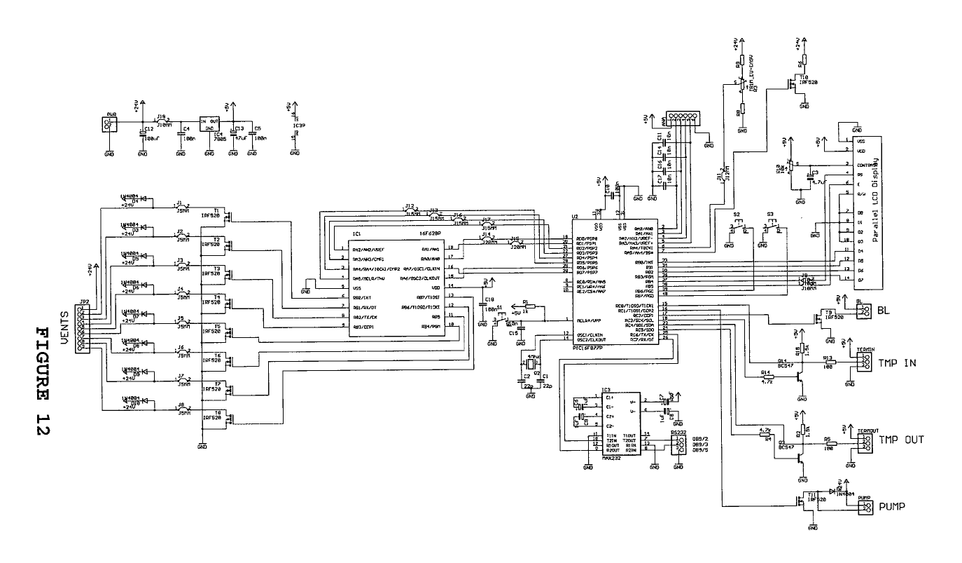

FIG. 11 shows a scheme of joining the micropneumatic elements (microcompressors, hand pump, air ducts, electronvalves, exhaust valves and jets) onto the thermoinsulative chambers. The micropneumatic elements are positioned on a detachable carrier, as can be seen in FIG. 10.

The construction of the microcontroller system, important for the construction of garment with adjustable microclimatic conditions, is depicted by the electric scheme in FIG. 12.

The system is based on two microcontrollers. More powerful one, Microchip designated PIC16F877P, is used in measuring, actuation of the microcompressor, inlet and outlet valves, as well as for the monitoring of the garment in adapting microclimatic conditions, while the smaller microcontroller, manufactured by the same company and designated PIC16F628P, is used to rationalize the consumption of electric energy through complex control of actuating the consumers in the system and employing the PMW supplying of the consumers.

The microcontrollers are interconnected through a data bus, while the other part of the data bus is linked from the microcontroller PIC16F877P to the parallel LCD display.

The microcontroller system also includes the integrated circle IC3, designated MAX232, by Microchip. The integrated circle IC3 is a level converter, and enables serial communication with the outside computer. The outside computer can through a connector designated DB9/2, DB9/3 and DB9/5, and the aim is to program the microcontroller and perform diagnostics.

The upper part of the electric scheme shows six-pole connector, designated ANA, which is used to connect the sensory bus for the analogous signals from the measuring amplifier of the pressure sensor in the thermoinsulative chambers, to be guided to the A/D converters of the microcontroller PIC16F877P, over the data bus. On the right of the abovementioned connector is the tension divider, used for measuring the electric tension of the battery set, to establish the level of charge, as well as the MOSFET transistor T10, designated IRF520, which checks, through the resistor R6, the state and charge of the battery system from time to time.

There are three buttons in the microcontroller system. The button S1 is used to reset the microcontroller system, while the buttons S2 and S3 are used for the software control of the system.

The data are displayed on a parallel LCD display of the alphanumerical type, which can show 16 digits in two lines. The contrast of display is set by a trimmer potentiometer, designated R10. The display has the option of back light as well. The back light is linked with a connector designated BL, through the transistor T9. To save energy, back light is also controlled by the PWM control system.

The right side of the electric scheme shows connectors for temperature sensors. The last connector on the right side of the scheme is the one designated PUMP, which is used to connect the microcompressor. The microcompressor is actuated by a signal from the attachment 16 of the microcontroller PIC16F877P, which activates the MOSFET transistor T11 that is used as an amplifier for the output signal, since the microcontroller is not strong enough to power the microcompressor in a direct manner.

The left side of the electric scheme shows eight MOSFET transistors, from T1 to T8. These transistors are actuated by the signals from the microcontroller PIC16F628P, which is in charge of rational electric energy consumption. The outlet signals from the microcontroller are of the PWM type, and they actuate the bases of the transistors T1 to T8. These transistors are used as outlet amplifiers to power the inflating and deflating electrovalves for the thermoinsulative chambers.

The electrovalves are connected to the connector JP2, designated VENTS, through an actuator bus. The microcontroller assembly gets the energy through tension stabilizer IC4, designated 7805.

FIG. 3 shows a scheme of connecting micropneumatic elements (microcompressor, hand pump, air ducts, electrovalves, exhaust valves and jets) to the thermoinsulative chambers. The mictropneumatic elements are situated onto the detachable carrier, as can be seen in FIG. 1.

### APPLICABILITY

The controllable ribbed thermoinsulative chamber of continually adjustable thickness is the essence of this invention. Its primary application is the manufacture of articles of clothing and/or other wrappers, where there is a need for altering thermal protection, as defined by a pre-determined protocol of behavior.

The design of the invention is primarily aimed at garments used for activities and stay in extremely cold or warm conditions, where the changes in the ambiental temperatures are frequent and bodily activities constant. Wide possibilities of application can be expected in military and police, maintenance, watchmen services, security of open objects and premises, workers in cold storages, athletes, such as mountain climbers, alpinists, yachtsmen and similar situations and professions.

If the adaptation is necessary in a cold environment regarding increased thermal protection of the garment, a microcompressor and electrovalves are actuated to blow in the air, starting inflating the chambers. Their thickness is continually increased as the air pressure in them increases. Garment thermal insulation is improved in this way, i.e. the amount of body heat exhausted into the environment is reduced.

In case the need arises, due to, for example increased body activity, of reducing thermal protection, exhaust valves are actuated and the air is forced out of the chambers, their thickness is reduced and thermoinsulative properties with it.

A tight cover of elastic knitted fabric, which encases the whole system of chambers, aids in pushing the air out of the chambers.

In case when adequate cooling of the body cannot be accomplished with totally deflated chambers and minimal thermal insulation, forced air circulation within the garment is actuated, as previously described, employing cooling jets to which the cool compressed air from the microcompressor is re-directed.

If driving batteries are emptied beyond certain limit, or failure occurs in the control system, thermoinsulative chambers can be inflated using a hand pump on the air ducting system.

Sweat-saturated air, released into the microclime within the garment in wearing, is exhausted through connecting structures made of net-like fabrics or semi-permeable membranes. In case of increased cooling, when the jets are activated, air flow, body cooling and elimination of sweat from the garment microclime into the environment are additionally increased.

The water condensed in the chambers is occasionally released manually, using exhaust valves designed for the purpose.

Thermoinsulative chambers are occasionally washed, and parts of the technical system repaired. It can be done so that the carrier with the concentrated elements is detached from the system of thermoinsulative chambers.

### LIST OF NUMERICAL DESIGNATIONS USED

1. Ribbed thermoinsulative chamber
2. Connecting net-like structure or semi-permeable membrane
3. Air-tight edges
4. Inner seams
5. Openings for inflating and deflating chambers
6. Opening (and valve) for releasing the condensate
7. Pneumatic electrovalves
8. Pressure sensor
9. Microcompressor
10. Air ducts
11A. Sensors for monitoring inner microclimatic conditions
11B. Sensors for monitoring ambient conditions
12. Control system
13. Power system
13A. Attachment for external power
14. Bus system
15. Testing compressor
16. Measuring sensor of pressure at testing
17. Digital pressure gauge
18. Detachable carrier
19. Jet for forced circulation
20. Attaching joints
21. Hand pump

1.-10. (canceled)

11. Controllable ribbed thermoinsulative chamber:
made of highly elastic thin polymer foil with the edges airtightly welded and where said chamber has openings for blowing air in and out for changing a volume and therefore thermal flux across said chamber, and
where said chamber is controlled by a control system which controls pneumatic electro valves, supplying the air from a microcompressor through one or more ducts according to the information picked from the sensors and stored protocol,
wherein:
said chamber has inner seams that define a ribbed structure shape and a maximum volume of said chamber,
said chamber is further equipped with an opening for releasing condensate out from the chamber, and
where the said chamber is equipped with a net-like structure or semi-permeable membranes that enable forced deflation of the chamber and their structural connection with the other chambers.

12. An article of clothing for thermal protection of a targeted body part formed by one or more thermoinsulative chambers defined in claim 11, and controlled by one or more control systems, wherein:
said chambers are situated between an outer fabric shell and an inner interlining, being mutually connected via the net-like structure or semi-permeable membranes which enables the forced deflation of the chambers;
where said net-like structure or semi-permeable membranes facilitate sweat-saturated air removal from the garment microclimatic environment and space between the chambers into the outer environment;
where said net-like structure or semi-permeable membranes forms connecting channel structures for air circulation and forced cooling via an air stream from nozzles situated into said structures, and
one or more openings for releasing the condensate out from the chambers.

13. The article of clothing according to claim 12, wherein the control system is equipped with a special consumption control power system, while the lower edges of the clothing has detachable mounted elements for controlling one or more chamber thicknesses.

14. Use of article of clothing defined in claim 12 for police purposes, maintenance services, watchmen, security services for open objects and premises, workers in cold storages, athletes, mountain climbers, alpinists, sailing boaters, and on places where the environmental temperature changes rapidly.

15. Use of the ribbed thermoinsulative chamber of claim 11 for forming an adaptive thermal bridge with a predetermined control of thermal flux through the chamber.

16. Use of article of clothing defined in claim 13 for police purposes, maintenance services, watchmen, security services for open objects and premises, workers in cold storages, athletes, mountain climbers, alpinists, sailing boaters, and on places where the environmental temperature changes rapidly.
